(19) United States
(12) Patent Application Publication
(10) Pub. No.: US 2025/0334747 A1
(43) Pub. Date: Oct. 30, 2025

(54) Hybrid Fiber and Electrical Connector with Conductive Latching and Protector

(71) Applicant: Panduit Corp., Tinley Park, IL (US)

(72) Inventors: Yu Huang, Orland Park, IL (US); Jose M. Castro, Naperville, IL (US); Masud Bolouri-Saransar, Orland Park, IL (US); Ryan N. Murphy, Monee, IL (US); Bulent Kose, Burr Ridge, IL (US); Thomas M. Sedor, Orland Park, IL (US); Satish I. Patel, Roselle, IL (US); Benjamin S. Novak, Lockport, IL (US)

(73) Assignee: Panduit Corp., Tinley Park, IL (US)

(21) Appl. No.: 19/187,357

(22) Filed: Apr. 23, 2025

Related U.S. Application Data
(60) Provisional application No. 63/638,020, filed on Apr. 24, 2024.

(51) Int. Cl. G02B 6/38; H01R 13/502

(52) U.S. Cl. CPC G02B 6/3817; G02B 6/3825; G02B 6/3849; H01R 13/502

(57) ABSTRACT

A hybrid optical and electrical connector assembly is disclosed for utilizing electrically conductive parts to enable transmission via both fiber and electrical/power signals. The hybrid optical and electrical connector assembly solution disclosed herein may utilize form factors borrowed from existing optical connectors and adapters, which provides the benefits of a low cost, simple field termination, and reliable optical communications with the added benefit of including metallic conductors for remote electrical powering.

### CROSS-REFERENCE TO RELATED APPLICATION(S)

This application claims benefit to U.S. Provisional Patent Application No. 63/638,020, filed Apr. 24, 2024, the entirety of which is hereby incorporated by reference herein.

### TECHNICAL FIELD

A hybrid optical and electrical connector assembly is disclosed for utilizing electrically conductive parts to enable transmission via both fiber and electrical/power signals. The hybrid optical and electrical connector assembly solution disclosed herein may utilize form factors borrowed from existing optical connectors and adapters, which provides the benefits of a low cost, simple field termination, and reliable optical communications with the added benefit of including metallic conductors for remote electrical powering.

### BACKGROUND

Fiber to the home (FTTH) networks have become integral to modern telecommunications infrastructure, providing high-speed internet access and multimedia services directly to residences. In these networks, optical fiber is the primary medium for transmitting data due to its exceptional bandwidth and minimal signal loss characteristics. However, one challenge faced in FTTH deployments is the need for simultaneous power distribution to FTTH endpoints to supply electric power to various network elements, such as Optical Network Units (ONUs), Customer Premises Equipment (CPE), or surveillance cameras, alongside data transmission.

Integrating optical fiber and electrical within the FTTH environment necessitates efficient and reliable connectivity solutions.

### SUMMARY

Disclosed herein are exemplary new hybrid connector and adapter systems that are configured to provide a solution for misaligning proper polarity when connecting hybrid cables together using connector and adapter assemblies.

A hybrid cable connector is disclosed, the hybrid cable connector comprising a fiber component including a fiber ferrule, the fiber component configured to receive a fiber signal from a hybrid cable; an inner housing comprising: a first side wall, a second side wall, a first conductive plate located on the first side wall, the first conductive plate configured to receive a first electrical signal from a first conductive wire included in the hybrid cable, a second conductive plate located on the second side wall, the second conductive plate configured to receive a second electrical signal from a second conductive wire included in the hybrid cable, and an outer housing configured to be installed over the inner housing, the outer housing including a protective shield configured to cover at least a portion of the first conductive plate and at least a portion of the second conductive plate.

A hybrid cable adapter is disclosed, the adapter comprising a first side housing including an opening for inserting a first hybrid connector, a second side housing including an opening for inserting a second hybrid connector, and a split sleeve holder including: a first side fiber tunnel, a second side fiber tunnel coupled to the first side fiber tunnel, a first pair of conductive latches configured to attach to the first side housing, and a second pair of conductive latches configured to attach to the second side housing.

A detailed description of these and other non-limiting exemplary embodiments of the hybrid cable assembly systems is set forth below together with accompanying drawings.

### BRIEF DESCRIPTION OF THE DRAWINGS

FIG. 1 shows a perspective view of an exemplary fiber optic connector.

FIG. 2A shows a top-down view of an exemplary hybrid connector and adapter assembly system, according to some embodiments of the present disclosure.

FIG. 2B shows a top-down view of the exemplary fiber connector and adapter assembly system shown in FIG. 2A, where the connectors have been inserted into the adapter, according to some embodiments of the present disclosure.

FIG. 3A shows a top-down view of an inner housing of the hybrid connector and the hybrid adapter shown in FIG. 2A, according to some embodiments of the present disclosure.

FIG. 3B shows a side view of the inner housing of the hybrid connector and the hybrid adapter shown in FIG. 3A, according to some embodiments of the present disclosure.

FIG. 3C shows a side view of the hybrid connector and the hybrid adapter shown in FIG. 3B, where an outer housing of the hybrid connector has been additionally installed, according to some embodiments of the present disclosure.

FIG. 3D shows a top-down view of the hybrid connector inserted into the hybrid adapter shown in FIG. 3A, according to some embodiments of the present disclosure.

FIG. 4A shows a top-down view of an exemplary hybrid connector and adapter assembly system shown, where the hybrid connector includes a sliding protector, according to an alternative embodiment of the present disclosure.

FIG. 4B shows a top-down view of the exemplary hybrid connector and adapter assembly system shown in FIG. 4A, where the hybrid connector has been inserted into the hybrid adapter, according to some embodiments of the present disclosure.

FIG. 5A shows a top-down view of an assembly system that includes the hybrid connector and the hybrid adapter shown in FIG. 4A, prior to an installed state, according to an alternative embodiment of the present disclosure.

FIG. 5B shows a top-down view of the hybrid connector and hybrid adapter assembly system shown in FIG. 5A, in an installed state, according to some embodiments of the present disclosure.

FIG. 6 shows a perspective view of an exemplary hybrid connector, according to an alternative embodiment of the present disclosure.

FIG. 7 shows a front-side view of the hybrid connector shown in FIG. 6, according to some embodiments of the present disclosure.

FIG. 8 shows a perspective view of an exemplary hybrid adapter for receiving the hybrid connector shown in FIG. 6, according to some embodiments of the present disclosure.

FIG. 9 shows an exploded view of the hybrid adapter shown in FIG. 8, according to some embodiments of the present disclosure.

FIG. 10A shows a perspective view of an assembly system including the hybrid connector shown in FIG. 6 and the hybrid adapter shown in FIG. 8, prior to be in an installed state, according to some embodiments of the present disclosure.

FIG. 10B shows a perspective view of the assembly system shown in FIG. 10A, in an installed state, according to some embodiments of the present disclosure.

### DETAILED DESCRIPTION

Detailed non-limiting embodiments of a hybrid optical and electrical connector and adapter are disclosed herein. However, it is to be understood that the disclosed embodiments may merely be exemplary and may take various and alternative forms. The figures may not be necessarily to scale, and features may be exaggerated or minimized to show details of particular components. Therefore, specific structural and functional details of the hybrid connector and adapter disclosed herein may not be interpreted as limiting, but merely as a representative basis for teaching one skilled in the art.

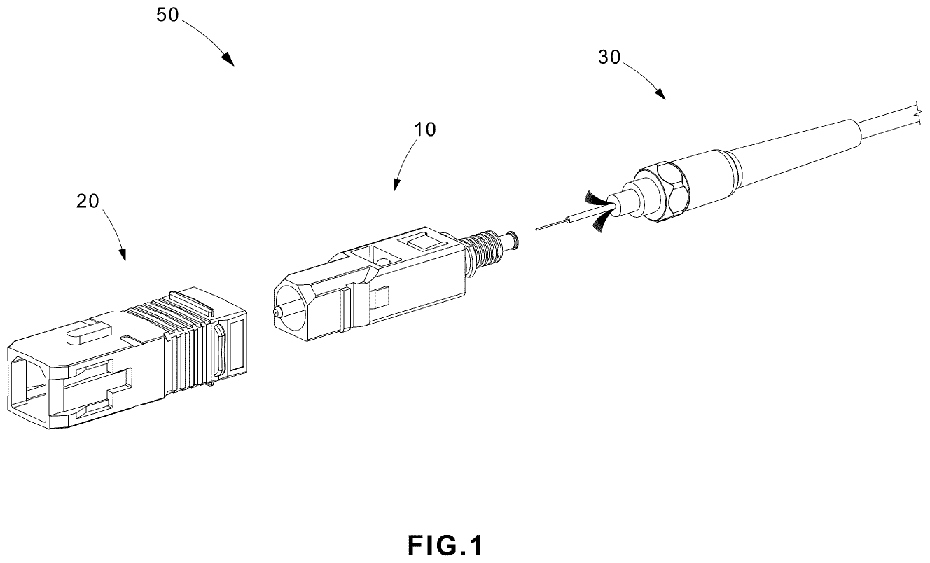

The hybrid connector and adapter systems disclosed herein provide a solution where conductors may be included inside the form factor of existing fiber optic connectors and fiber optic adapters, so that the conductors may be connected to electrical cables included in hybrid cables. In other words, these hybrid connectors may be used to terminate the ends of such hybrid cables that include both fiber and electrical conductor wires. So, this solution is able to combine both optical and electrical connections in one connector. This provides beneficial savings on materials as separate fiber connectors and electrical connectors are not needed, reductions in the overall hybrid connector size compared to other hybrid connectors, and potential reduction in installation time when using the hybrid connectors and adapters described herein. For example, FIG. 1 shows an exemplary fiber connector 50 that may serve as one of the bases for the form factor of the hybrid connector described herein. The fiber connector 50 is described in more detail in U.S. Pat. No. 7,011,454, the contents of which are incorporated by reference herein. The fiber optic connector 50 shown in FIG. 1 is field terminable and includes an inner housing 10, outer housing 20, and also features a stub fiber 30 with one pre-polished end, allowing for rapid assembly with a field fiber, resulting in the swift creation of a fiber optic connector.

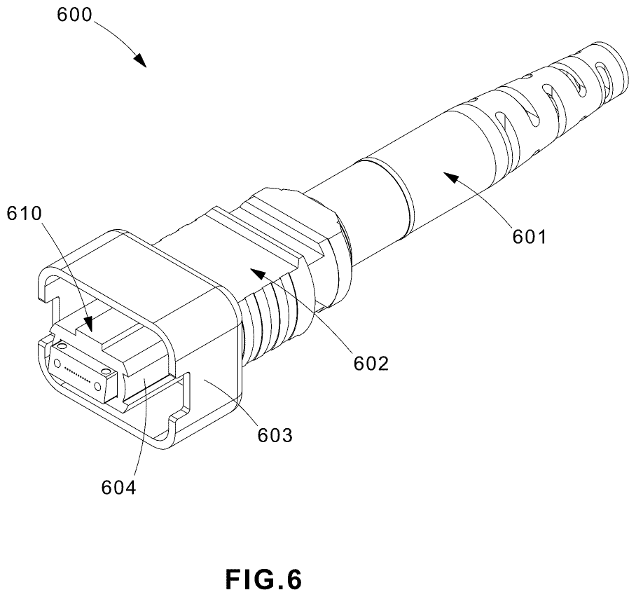

The solution disclosed herein relates to an innovative hybrid fiber connector and adapter assembly system that builds upon the foundation of an established connector and adapter assembly system. For example, the embodiments shown and described in FIGS. 1-5B relate to an SC type connector and adapter. The embodiments shown in FIGS. 6-10B relate to an M PO type connector and adapter. This integrated assembly system provides a solution that seamlessly combines a fiber optic circuit with an electrical circuit. Like a conventional adapter, this adapter is compatible with standard-sized patch panels and offers straightforward installation.

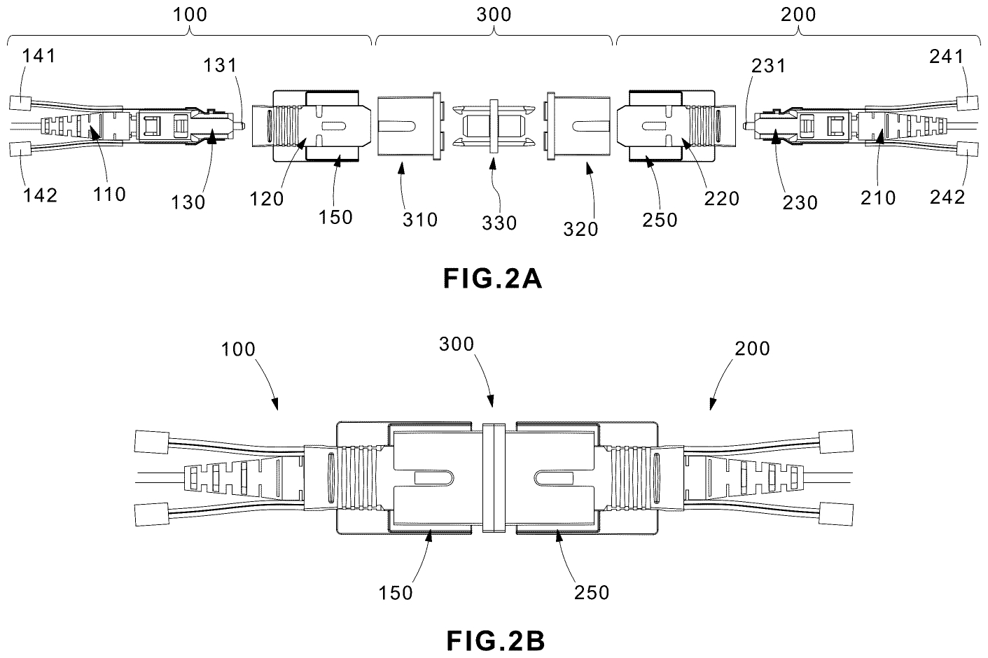

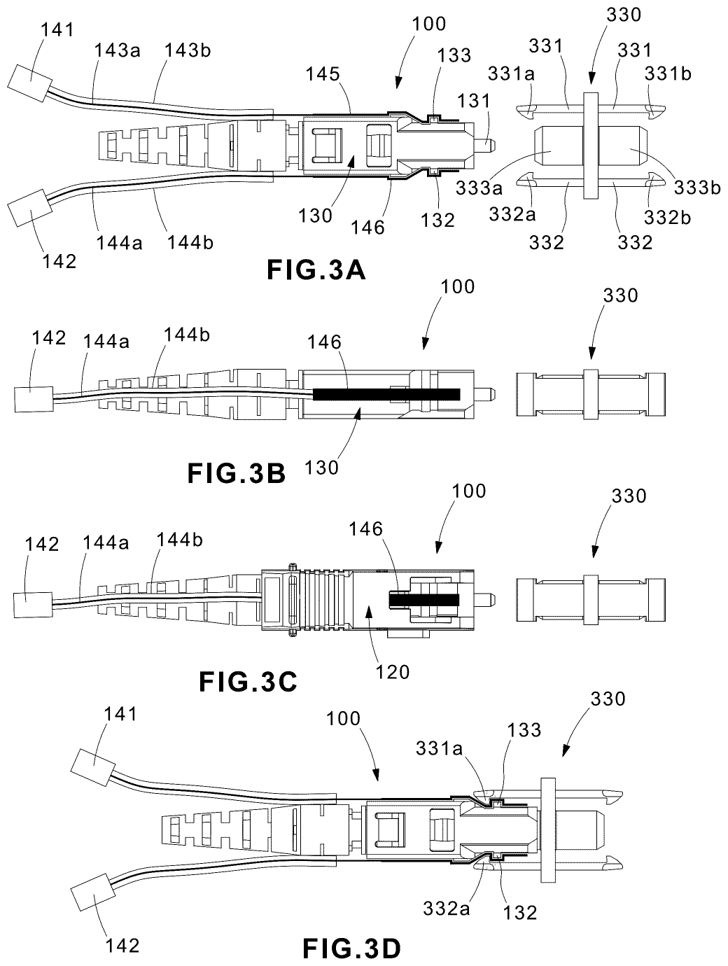

To better understand the existing fiber optic connector and adapter, FIGS. 2A-2B illustrate the current hybrid connector 100, 200 and hybrid adapter 300 assembly components, as shown in the SC type form factor, where two of the hybrid connectors 100, 200 are shown being installed into both sides of the hybrid adapter 300. The hybrid connector 100 is comprised of components such as, for example, a boot 110, an inner housing 130, an outer housing 120, and a fiber ferrule 131. The outer housing 120 includes a safety cover 150, which is a portion of the outer housing 120 that is configured to cover the conductive plates 145, 146 installed onto the inner housing 130, as shown in FIGS. 2B and 3C. The hybrid connector 100 also includes conductive sleeves 141, 142 including conductive wires for routing in electrical signals received from the conductive wires included in a hybrid cable, where the conductive wires will be routed through the hybrid connector 100 to electrically couple to conductive portions on the hybrid adapter 300, as will be described in more detail below.

The hybrid connector 200 is simply another instance of the hybrid connector 100, so the hybrid connector 200 is also comprised of a boot 210, an inner housing 230, an outer housing 220, and a fiber ferrule 231. The outer housing 220 includes a safety cover 250, which is a portion of the outer housing 220 that is configured to cover conductive plates installed onto the inner housing 230, as shown in FIG. 2B. The hybrid connector 200 also includes conductive sleeves 241, 242 including conductive wires for routing in electrical signals received from the conductive wires included in a hybrid cable, where the conductive wires will be routed through the hybrid connector 200 to electrically couple to conductive portions on the hybrid adapter 300, as will be described in more detail below.

The hybrid adapter 300 includes a first half housing 310, a second half housing 320, and a split sleeve holder 330. The split sleeve holder 330 includes latches 331a, 331b, 332a, 332b as shown in more detail in FIG. 3A. These latches 331a, 331b, 332a, 332b are configured for connecting the first half housing 310 and the second half housing 320 to the split sleeve holder 330, to form the overall hybrid adapter 300.

FIG. 3A shows a top-side view looking down at the hybrid connector 100 and the hybrid adapter 300, according to an embodiment. In particular, FIG. 3A shows a conductive wire 143a coming in from the conductive sleeve 141, where the conductive wire 143a is protected by being routed inside an insulation sleeve 143b. The conductive wire 143a is routed to be electrically connected to a conductive plate 145 included on an outer part of the inner housing 130. The conductive wire 143a is configured to receive an electrical signal received from a conductive wire included in a hybrid cable including both optical fiber(s) and conductive wire(s). As the hybrid cable will likely include a pair of conductive wires, the conductive sleeve 142 is shown to include another conductive wire 144a for electrically connecting to another conductive wire included in the hybrid cable. The conductive wire 144a is protected by an insulation sleeve 144b as the conductive wire 144a is routed to be electrically connected to a conductive plate 146 included on an outer part of the inner housing 130. In particular, the conductive plates 145, 146 are placed over a protrusions 132, 133 on the inner housing 130.

The latches 331a, 331b, 332a, 332b include electrically conductive material, such that when the hybrid connector 100 is installed into the hybrid adapter 300, a portion of the conductive plates 145, 146 (e.g., portions of the conductive plates 145, 146 that are placed over the protrusions 132, 133) will contact the latches 331a, 332a on the first side which will carry electrical signals through to the latches 331b, 332b on the second side of the hybrid adapter 300. An optical signal carried by an optical fiber in the cable may be transmitted through the hybrid connector 100 and out the fiber ferrule 131 to be transmitted through a first side fiber tunnel 333a and a second side fiber tunnel 333b of the hybrid adapter 300, as a typical fiber connector and fiber adapter would, to be received by the fiber ferrule 231 of the hybrid connector coupled to the second side fiber tunnel 333b. In this way, the hybrid connector 100 and hybrid adapter 300 are able to implement transmission of electrical power signals coming from a hybrid cable including both optical fiber and a conductor wire.

FIG. 3B provides a side view of the hybrid connector 100 and the hybrid adapter 300 shown in FIG. 3A, while FIG. 3C shows the same side view of the hybrid connector 100 and the hybrid adapter 300 shown in FIG. 3B, but with the added inclusion of the outer housing 120 installed over the inner housing 130 of the hybrid connector 100. FIG. 3C is illustrated to remove a portion of the safety cover 150 to offer a view inside the outer housing 120 to provide a view into a location of the conductive plate 146.

FIG. 3D illustrates a top down view of the hybrid connector 100 and the hybrid adapter 300 in an installed state, where the hybrid connector 100 is shown installed into the hybrid adapter 300 such that the portion of the conductive plates 145, 146 that are positioned over the protrusions 132, 133 are in contact with the conductive portions of the latches 331a, 332a on the first side of the split sleeve holder 330 included in the hybrid adapter 300. In this way, an electrical connection between the hybrid connector 100 and the hybrid adapter 300 may be established.

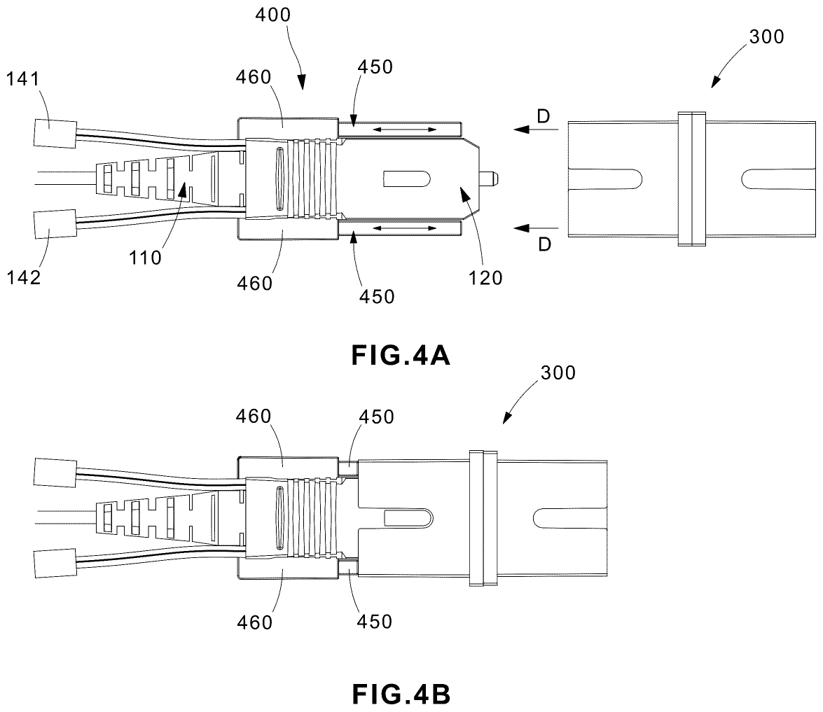

FIGS. 4A-4B illustrates a hybrid connector 400 according to an alternative embodiment where the outer housing 120 includes a different design for a safety cover. Other components of the hybrid connector 400 remain same as for the hybrid connector 100 described earlier, and therefore the same component reference numbers may be used in describing the hybrid connector 400.

The outer housing 120 in the hybrid connector 400 includes a holder 460, where the holder 460 includes a chamber housing for receiving sliding protectors 450. When the sliding protectors 450 are extended out while not installed into the hybrid adapter 300, the sliding protectors 450 will cover the conductive plates 145, 146 that are included on the inner housing 130 of the hybrid connector 400, as shown in FIG. 4A.

When the hybrid connector 400 is inserted into the hybrid adapter 300, the sliding protectors 450 will abut against a surface of the hybrid adapter 300 and be pushed into the holder 460 while still being extended outside the holder 460 enough to close off any gap between the outer housing 120 and the hybrid adapter 300 when the hybrid connector 100 is fully inserted into the hybrid adapter 300, as shown in FIG. 4B. The sliding protector 450 may be biased by a spring housed within the holder 460, so that when the hybrid connector 100 is detached again from the hybrid adapter 300 the sliding protector 450 will be pushed out to the extended position to cover the conductive plates 145, 146 again.

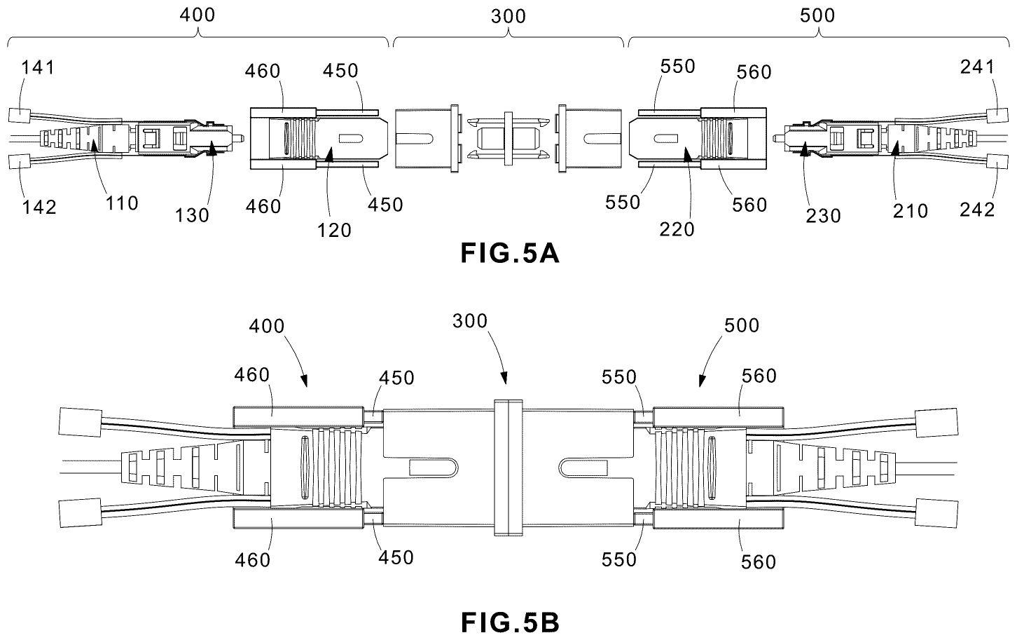

FIG. 5A shows the hybrid connectors 400, 500 and hybrid adapter 300 as an assembly system, where the hybrid connectors 400, 500 are the same embodiments using the sliding protectors 450, 550. FIG. 5B shows the hybrid connectors 400, 500 installed into both sides of the hybrid adapter 300, such that the sliding protectors 450, 550 from the hybrid connectors 400, 500 are shown still extended out from their respective holders 460, 560 to close the gap that remains between the hybrid connectors 400, 500 and the hybrid adapter 300.

As mentioned, the hybrid connectors 100, 200, 400, 500 and the hybrid adapter 300 have been shown according to exemplary embodiments where the fiber connector is in the SC connector form factor. However, the featured solutions for implementing the hybrid connectivity may be applied to other connector/adapter form factors such as SN, LC, MDC, MPO, CS, or other known forms. For example, FIGS. 6-10B show an exemplary embodiment where a hybrid connector 600 and hybrid adapter 700 are made in the MPO type form factor.

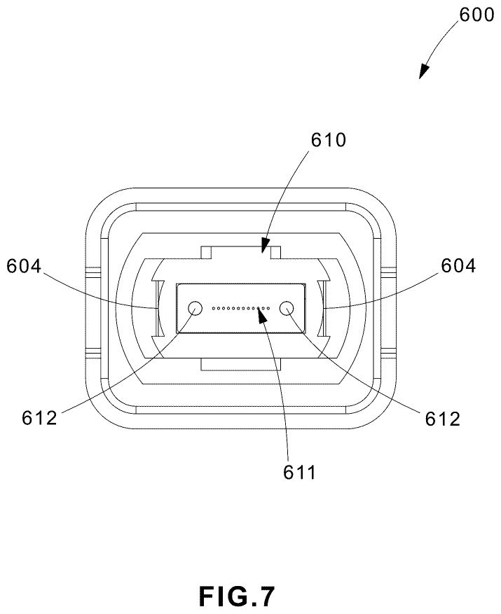

FIG. 6 shows a perspective view of the hybrid connector 600. The hybrid connector 600 includes an MPO type fiber connector body 610. FIG. 7 further shows a front-side view of the hybrid connector 600 showing MPO components such as a plurality of fiber ferrules 611 and pins 612 on a face of the M PO type fiber connector body 610. The MPO type fiber connector body 610 also includes a key up tab. In addition to the MPO type fiber connector body 610, the hybrid connector 600 includes a conductive surface 604 running along a length of two sides to the M PO type fiber connector body 610. FIG. 7 shows another view of the conductive surfaces 604 running along the two sides of the MPO type fiber connector body 610. The sides that include the conductive surface 604 may be a first side and a second side that are opposite to each other, as shown in FIG. 7.

The hybrid connector also includes a protective shield 603 that covers the conductive surfaces 604. For example, each conductive surface 604 may be recessed within the protective shield 603 so that the conductive surfaces 604 are kept away from human contact.

A first conductive wire from a hybrid cable may run along an internal portion of the hybrid connector 600 to connect to a first conductive surface 604 on the first side, and a second conductive wire from the hybrid cable may run along an internal portion of the hybrid connector 600 to connect to a second conductive surface 604 on the second side.

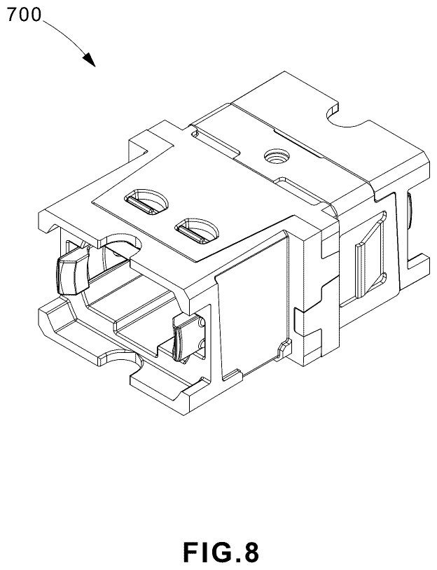

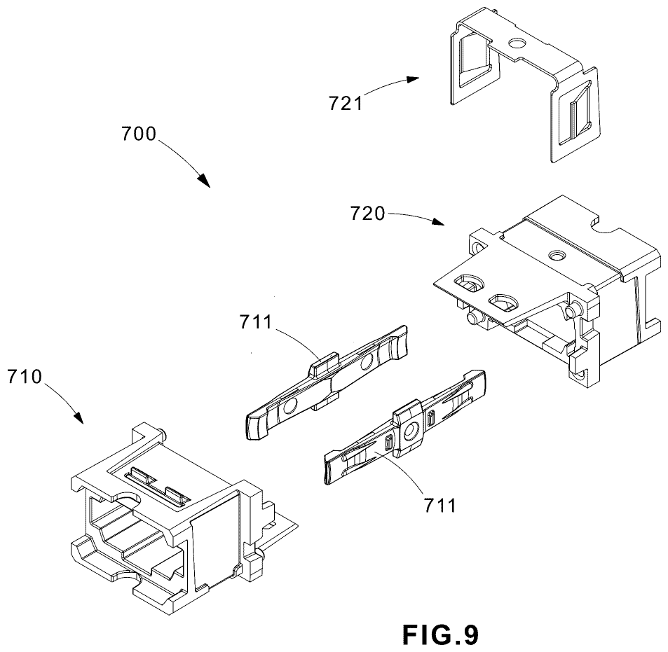

FIG. 8 shows a perspective view of the hybrid adapter 700. FIG. 9 shows an exploded view of the hybrid adapter 700, that shows different components that may comprise the hybrid adapter 700. For example, the hybrid adapter 700 includes two conductive latches 711, a first half body 710, a second half body 720, and a cover 721. The conductive latches 711 are configured to contact the conductive surfaces 604 of the hybrid connector 600 when the hybrid connector 600 are installed into the hybrid adapter 700, such that an electrical signal may be transmitted from the hybrid connector 600 installed at the first half body 710 to the hybrid connector 600 installed at the second half body 720, via the conductive latches 711 inside the hybrid adapter 700.

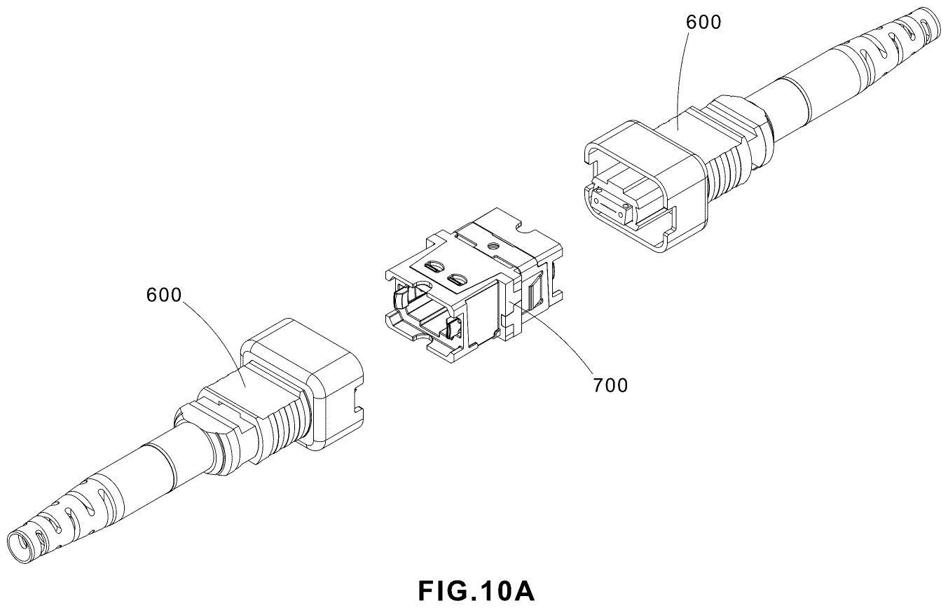

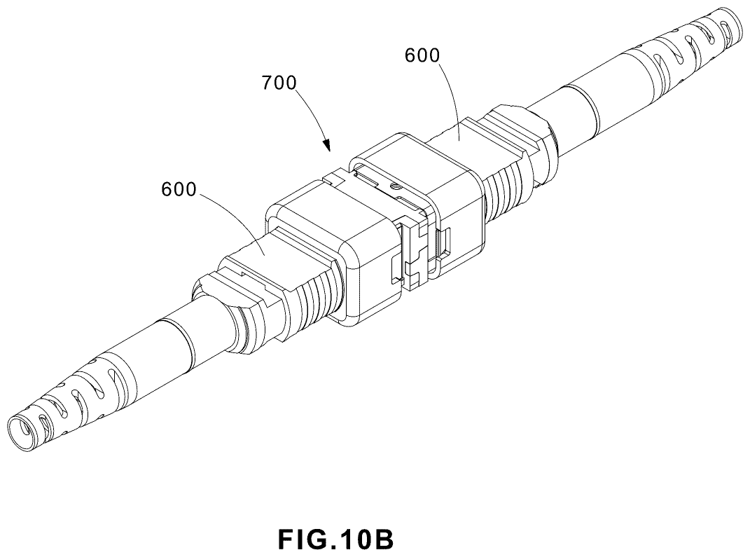

FIG. 10A shows the hybrid connectors 600 prior to being installed into the hybrid adapter 700. FIG. 10B shows the hybrid connectors 600 installed into both sides of the hybrid adapter 700. When the hybrid connectors 600 are installed into the hybrid adapter 700, an electrical signal may be transmitted from the hybrid connector 600 installed at the first half body 710 to the hybrid connector 600 installed at the second half body 720, via the conductive latches 711 inside the hybrid adapter 700.

A hybrid fiber and electrical connector and adapter system containing two SC type fiber optic connectors and a SC fiber optic adapter is disclosed, wherein the two fiber optic connectors can be connected to each other via the fiber optic adapter, wherein at least one latch of the hybrid fiber and electrical adapter is conductive, wherein at least one surface of the connector inner housing that contacts the adapter latch has at least one connector plate attached to it, wherein the conductive plate on the connector's inner housing contacts the conductive latch after the connector is inserted into the adapter.

Also disclosed is the hybrid fiber and electrical connector, wherein a safety protector is located next to the conductive plate to shield the conductive plate and form a gap between the safety protector and the conductive plates to allow the hybrid fiber and electrical connector to be inserted into the hybrid fiber and electrical adapter.

Also disclosed is the hybrid fiber and electrical connector, wherein a sliding protector is located next to the conductive plate to shield the conductive plate. The sliding protector is slidable to insert the hybrid fiber and electrical connector into the hybrid fiber and electrical adapter.

Also disclosed is the hybrid fiber and electrical connector, wherein a conductive sleeve is connected to the conductive plate through an electrical wire to allow the field electrical cable to be connected to the hybrid fiber and copper connector through the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to create a fiber optic connector assembly.

Also disclosed is the hybrid fiber and copper connector and adapter system, wherein the electrical adapter can be installed in a patch panel.

Also disclosed is the hybrid fiber and copper connector and adapter system, wherein the electrical adapter can be installed in a splice cassette.

Disclosed is a hybrid fiber and electrical connector and adapter system containing two SN-type fiber optic connectors and a SN fiber optic adapter, wherein the two fiber optic connectors can be connected to each other via the fiber optic adapter, wherein at least one latch of the hybrid fiber and electrical adapter is conductive, wherein the two surfaces of the connector inner housing that contacts the adapter latch have connector plates attached to them, wherein the conductive plates on the contact inner housing contact the conductive latch after the connectors are inserted into the adapter.

Also disclosed is the hybrid fiber and electrical connector, wherein a safety protector is located next to the conductive plate to shield the conductive plate and form a gap between the safety protector and the conductive plates to allow the hybrid fiber and electrical connector to be inserted into the hybrid fiber and electrical adapter.

Also disclosed is the hybrid fiber and electrical connector, wherein a sliding protector is located next to the conductive plate to shield the conductive plate. The sliding protector is slidable to insert the hybrid fiber and electrical connector into the hybrid fiber and electrical adapter.

Also disclosed is the hybrid fiber and electrical connector, wherein a conductive sleeve is connected to the conductive plate through an electrical wire to allow the field electrical cable to be connected to the hybrid fiber and copper connector through the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to create a fiber optic connector assembly.

Also disclosed is the hybrid fiber and copper connector and adapter system, wherein the electrical adapter can be installed in a patch panel.

Also disclosed is the hybrid fiber and copper connector and adapter system, according to claim 8, wherein the electrical adapter can be installed in a splice cassette.

Disclosed is a hybrid SC fiber and electrical connector containing at least one SC fiber optic connector, wherein at least one surface of the connector inner housing that contacts the adapter latch has at least one connector plate attached to it, wherein a safety protector is located next to the conductive plate to shield the conductive plate and form a gap between the safety protector and the conductive plates to allow the hybrid fiber and electrical connector to be inserted into the hybrid fiber and electrical adapter.

Disclosed is a hybrid SC fiber and electrical connector containing at least one SC fiber optic connector, wherein at least one surface of the connector inner housing that contacts the adapter latch has at least one connector plate attached to it, wherein a sliding protector is located next to the conductive plate to shield the conductive plate. The sliding protector is slidable to insert the hybrid fiber and electrical connector into the hybrid fiber and electrical adapter.

Disclosed is a hybrid fiber and electrical adapter containing at least one SC fiber optic adapter, wherein at least one latch of the hybrid fiber and electrical adapter is conductive.

Disclosed is a hybrid SN fiber and electrical connector containing at least one SN fiber optic connector, wherein at least one surface of the connector inner housing that contacts the adapter latch has at least one connector plate attached to it, wherein a safety protector is located next to the conductive plate to shield the conductive plate and form a gap between the safety protector and the conductive plates to allow the hybrid fiber and electrical connector to be inserted into the hybrid fiber and electrical adapter.

Disclosed is a hybrid SN fiber and electrical connector containing at least one SN fiber optic connector, wherein at least one surface of the connector inner housing that contacts the adapter latch has at least one connector plate attached to it, wherein a sliding protector is located next to the conductive plate to shield the conductive plate. The sliding protector is slidable to insert the hybrid fiber and electrical connector into the hybrid fiber and electrical adapter.

Also disclosed is the hybrid fiber and electrical adapter containing at least one SN fiber optic adapter, wherein at least one latch of the hybrid fiber and electrical adapter is conductive.

Also disclosed is a hybrid MPO fiber and electrical connector and adapter system containing two MPO fiber optic connectors and an MPO fiber optic adapter, wherein the two MPO fiber optic connectors can be connected to each other via the MPO fiber optic adapter, wherein at least one latch of the hybrid MPO fiber and electrical adapter is electrically conductive, wherein at least one surface of the connector inner housing that contacts the adapter latch is electrically conductive, wherein the conductive surface on the connector housing and the conductive latch will form an electrical connection after the connector is inserted into the adapter.

According to this hybrid MPO fiber and electrical connector, a safety protector is located next to the conductive surface of the connector to shield the conductive surface, and a gap between the safety protector and the conductive surfaces allows the hybrid MPO fiber and electrical connector to be inserted into the MPO hybrid fiber and electrical adapter.

According to this hybrid MPO fiber and electrical connector, a sliding protector is located next to the conductive surface of the connector to shield the conductive surface. The sliding protector is slidable to allow the hybrid MPO fiber and electrical connector to be inserted into the hybrid MPO fiber and electrical adapter.

According to this hybrid MPO fiber and electrical connector, at least one conductive sleeve is connected to the conductive surface through an electrical wire to allow the field electrical cable to be connected to the hybrid MPO fiber and copper connector through the conductive sleeve.

According to this hybrid MPO fiber and electrical connector, the hybrid MPO fiber and electrical adapter can be installed in a patch panel.

According to this hybrid MPO fiber and electrical connector, the hybrid MPO fiber and electrical adapter can be installed in a splice cassette.

Also disclosed is a hybrid MPO fiber and electrical connector, wherein at least one surface of the connector inner housing that contacts the adapter latch is electrically conductive, wherein a safety protector is located next to the conductive surface of the connector to shield the conductive surface. A gap between the safety protector and the conductive surfaces allows the hybrid MPO fiber and electrical connector to be inserted into the MPO hybrid fiber and electrical adapter.

Also disclosed is a hybrid MPO fiber and electrical connector, wherein at least one surface of the connector inner housing that contacts the adapter latch is electrically conductive, wherein a sliding protector is located next to the conductive surface of the connector to shield the conductive surface. The sliding protector is slidable to allow the hybrid MPO fiber and electrical connector to be inserted into an MPO adapter.

According to this hybrid MPO fiber and electrical adapter, at least one latch of the hybrid MPO fiber and electrical adapter is electrically conductive.

The present disclosure thus describes systems, devices, and methods for implementing a hybrid cable connector and adapter assembly system and a method for utilizing the hybrid cable connector and adapter assembly system. As is readily apparent from the foregoing, various non-limiting embodiments of the hybrid cable connector and adapter assembly system, each individual device, and methods for utilizing the hybrid cable connector and adapter have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid cable connector comprising:
a fiber component including a fiber ferrule, the fiber component configured to receive a fiber signal from a hybrid cable;
an inner housing comprising:
a first side wall;
a second side wall;
a first conductive plate located on the first side wall, the first conductive plate configured to receive a first electrical signal from a first conductive wire included in the hybrid cable;
a second conductive plate located on the second side wall, the second conductive plate configured to receive a second electrical signal from a second conductive wire included in the hybrid cable; and
an outer housing configured to be installed over the inner housing, the outer housing including a protective shield configured to cover at least a portion of the first conductive plate and at least a portion of the second conductive plate.

2. The hybrid cable connector of claim 1, wherein the protective shield is comprised of a first sliding protector and a second sliding protector, wherein the outer housing further comprises:
a first holder configured to hold the first sliding protector such that the first sliding protector covers at least a portion of the first conductive plate; and
a second holder configured to hold the second sliding protector such that the second sliding protector covers at least a portion of the second conductive plate.

3. The hybrid cable connector of claim 1, further comprising:
a conductive sleeve including an insulation sleeve and a conductive wire housed within the insulation sleeve, wherein a first end of the conductive wire is electrically connected to the first conductive wire included in the hybrid cable and a second end of the conductive wire is electrically connected to the first conductive plate.

4. The hybrid cable connector of claim 1, wherein the first conductive plate is wrapped around the first side wall including a first protrusion, and the second conductive plate is wrapped around the second side wall including a second protrusion.

5. The hybrid cable connector of claim 1, wherein the fiber component corresponds to one of an SN, SC, LC, or MPO type fiber optic connector.

6. A hybrid cable adapter comprising:
a first side housing including an opening for inserting a first hybrid connector;
a second side housing including an opening for inserting a second hybrid connector; and
a split sleeve holder including:
a first side fiber tunnel;
a second side fiber tunnel coupled to the first side fiber tunnel;
a first pair of conductive latches configured to attach to the first side housing; and
a second pair of conductive latches configured to attach to the second side housing.

7. The hybrid cable adapter of claim 6, wherein the first pair of conductive latches are configured to electrically couple to a first conductive plate of the first hybrid connector inserted into the first side housing, and the second pair of conductive latches are configured to electrically couple to a second conductive plate of the second hybrid connector inserted into the second side housing.

8. The hybrid cable adapter of claim 6, wherein the first side fiber tunnel is configured to receive an optical signal from the first hybrid connector, and wherein the second side fiber tunnel is configured to receive the optical signal from the first side fiber tunnel and transmit it to the second hybrid connector.
